(19) United States
(12) Patent Application Publication
(10) Pub. No.: US 2014/0048456 A1
(43) Pub. Date: Feb. 20, 2014

(54) Herbal/Plant Sifter Apparatus and Method

(71) Applicants: Michael A. Adams, SR., San Jose, CA (US); Michael A. Adams, JR., San Jose, CA (US)

(72) Inventors: Michael A. Adams, SR., San Jose, CA (US); Michael A. Adams, JR., San Jose, CA (US)

(21) Appl. No.: 13/586,798

(22) Filed: Aug. 15, 2012

(51) Int. Cl. B07B 1/36

(52) U.S. Cl. 209/325

(57) ABSTRACT

A plant/herb sifting apparatus and method is disclosed. The apparatus comprises a containment unit having at least two levels of a sifting means; the containment unit comprising a primary containment, a secondary containment and a collection base to sift and refine a plant/herb component by a vibrating and agitation means. The apparatus further comprises a platform unit supporting the vibration and agitation means to which the containment unit is removably attached. The platform unit comprises a base and deck. The base houses a gear motor that provides the agitation through a connected arm to the deck, while a vibrator motor mounted to the deck provides a vibration motion. The levels of sifting means within the containment unit, comprise separated sieves increasing in fineness from top to bottom. The apparatus operates to sift under vibration and rapid agitation motions, providing an efficient sifting procedure to obtain a desired refined plant/herb component.

### BACKGROUND

1. Field of Invention

This invention relates to an herb or plant sifter system. In particular, a sifter system that operates to separate herb or plant roughage from a refined plant/herbal extract.

2. Background

Methods of separating desired plant or herb components from the entire plant or herb trim include manually or mechanically sifting the plant trim to obtain the refined plant component, such as herbal extract. Manual devices used include sieves, mesh, bubble bags or water bags. There also exist mechanical devices that separate plant components from plants with vigorous vibration. These mechanical devices separate plant components using vibratory separation. This vibratory separation is achieved with a single filter screen through multiple siftings. Further refining and sifting of plant components are sometimes needed to obtain a more purified product. Such devices are complicated, many requiring use of a liquid or fluid, inconvenient, time-consuming, messy, requiring extensive clean up and are inefficient.

Other mechanical devices utilize more than one screen for sifting, however, only function to extend the sifting duration. These devices do little to obtain a further refined or purified product. There are still other mechanical devices that contain multiple decks that utilize vibration for sifting; however these devices are not time efficient and not meant for portable use. These mechanical devices utilize significant time, cost and energy to obtain a sifted plant component, yet do not provided a further refined and essential purified plant component, of high quality free from unwanted plant debris. Indeed the demand for a device and method to more efficiently sift, separate and refine a desired plant component from the entire plant is desired.

### SUMMARY

Embodiments of the present invention solves the need for a portable, time and energy efficient method and device for sifting, separating and obtaining are fined plant or herb component from a plant or herb. An object of the invention is a portable apparatus which provides an effective and portable method of sifting and separating a plant or herb component utilizing both vibratory and agitation motions with multiple levels of refinement.

In one aspect, the apparatus in accordance with an embodiment of this invention relates to a plant or herb sifter. The apparatus comprises a containment unit and a platform. The containment unit is comprised of a primary containment, a secondary containment, a collection base and a lid. The primary containment fits and stacks into the secondary containment, and the secondary containment fits and stacks into the collection base. The lid covers the primary containment and prevents the contents of the primary chamber from escaping. The bottom surface of each of the primary and secondary containment comprises a sieve or are made of mesh/screen. Accordingly, when a plant is placed inside the primary chamber and sifted, the desired plant components pass through the primary mesh bottom (primary mesh level) and the secondary mesh bottom (secondary mesh level) to be collected from the collection base.

In another aspect of the invention, the platform of the apparatus comprises a deck and a base. The deck is designed with a retainer or mount to engage the containment unit securely to the surface of the deck. The retainer comprises wall units extending above the surface of the deck. In another embodiment, the deck comprises a recessed opening with vertical and horizontal supports within the opening to help secure the containment unit. The containment unit sits through the opening and rests on top of the horizontal support. The containment unit is further secured by a strap assembly that anchors the containment unit onto the deck during sifting. A vibrator motor mounted onto the deck provides a vibration motion.

In another aspect of the invention, the deck is further mounted on a base that serves to stabilize the apparatus on a surface such as the ground or table while in motion. The base may be box shaped and houses a gear motor connected to a rod that provides the agitation motion to the deck for sifting. The agitation and vibration motions are further enabled by two extension springs used to mount the deck at a height above the base which allows for the agitation rocking motion of the deck holding the containment unit.

In a further aspect, there is disclosed an apparatus for sifting plant components according to an embodiment of the present invention in which the apparatus sifts plant components by applying vibration and agitation motion to sifting plant components through two levels or grades of mesh.

In another aspect, there is further disclosed a method for sifting plant components according to an embodiment of the present invention in which the plant components are sifted through two levels or grades of mesh by applying vibration and rapid agitation motion to the plant.

These and other aspects of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 is a perspective view of the herb/plant sifter apparatus according to embodiment of the present invention.

FIG. 2 is an exploded view of the herb/plant sifter apparatus in accordance with an embodiment of the present invention.

FIG. 3A is a perspective view of the containment unit of the herb/plant sifter apparatus according to an embodiment of the present invention.

FIG. 3B is a cross-sectional side view of the containment unit of the herb/plant sifter apparatus according to an embodiment of the present invention.

FIG. 4 is a top view of a primary containment of the apparatus, with an attached mesh level, according to an embodiment of the present invention.

FIG. 5 is a side view of the primary containment, according to another embodiment of the present invention

FIG. 6 is a perspective view of the apparatus in a forward agitated position according to an embodiment of the present invention.

FIG. 7 is a perspective view of the apparatus in a backward agitated position according to an embodiment of the present invention.

FIG. 8 is a top perspective view of the platform unit of the apparatus according to an embodiment of the present invention.

FIG. 9 is a top, side perspective view of the platform unit of the apparatus according to an embodiment of the present invention.

FIG. 10 is a rear perspective view of the platform unit of the apparatus, showing a rear door in an open position, according to an embodiment of the present invention.

FIG. 11 is an inside view of the base illustrating a gear motor assembly of the apparatus according to an embodiment of the present invention.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles are terse and are for convenience only.

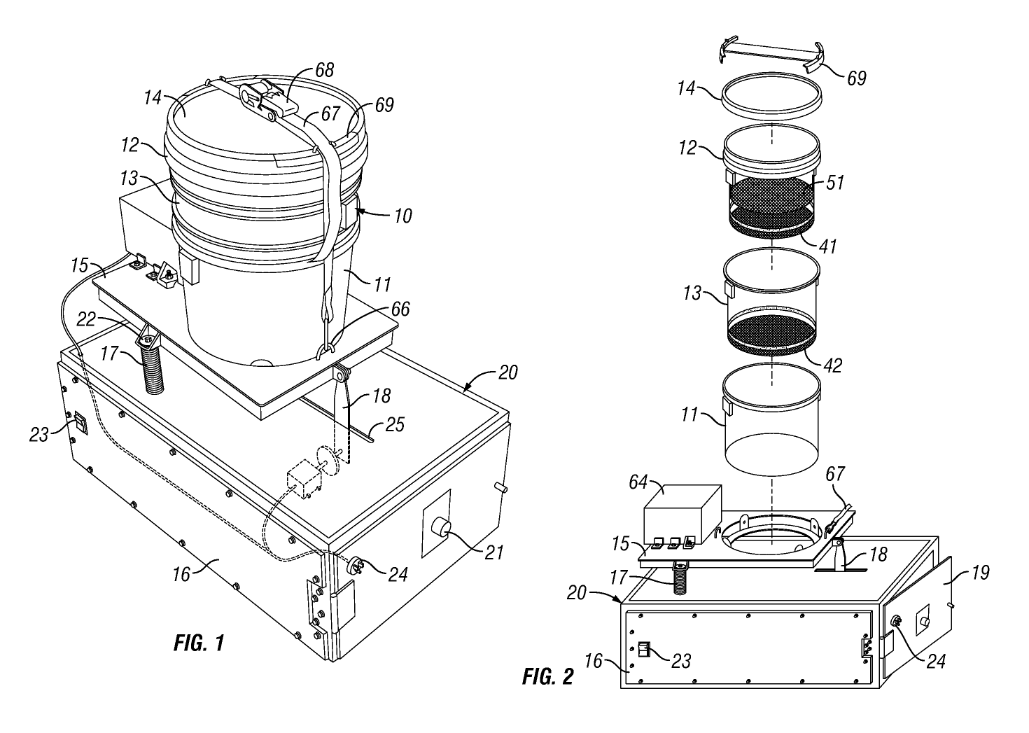

The present invention is a system, apparatus and method for using vibration and agitation to sift plants or herbs to obtain a desired plant or herb refined component such as a fine herbal extract. FIG. 1 illustrates a plant/herb sifting apparatus that comprises a containment unit 10 and a platform unit 20. This apparatus is a portable device that utilizes vibration and agitation motions, and two levels or grades of mesh to obtain a refined plant or herb components by sifting.

The containment unit 10 functions to contain and separate plant or herb components with multiple levels of sieving. In an embodiment of the present invention, as illustrated in FIGS. 1, 2 and 3A, 3B, the containment unit 10 is comprised of a collection base 11, a primary containment 12, a secondary containment 13 and a lid 14.

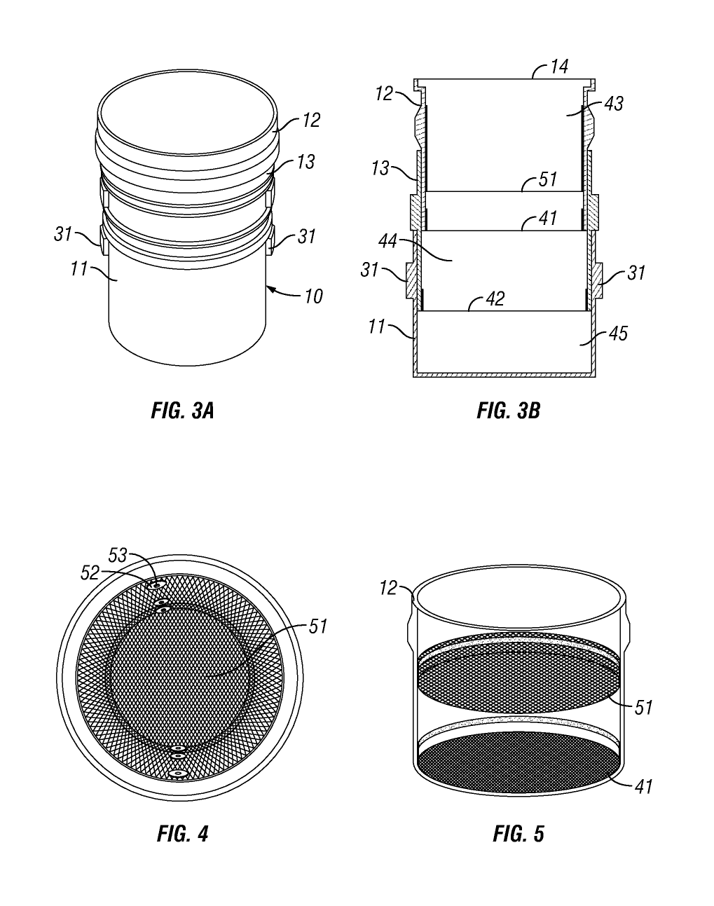

The primary containment 12 and secondary containment 13 serve to sift plant or herb components from the plant or herb. The primary containment 12 fits and stacks vertically into the secondary containment 13; and the secondary containment 13 fits and stacks into the collection base 11, as illustrated in FIGS. 2, 3A and 3B. In an embodiment of the present invention, the primary containment 12 and the secondary containment 13 are cylindrical containers with an open top, for example 3.5 or 5 gallon containers as illustrated in FIG. 3A. The containment may be formed of hard plastic or materials of a similar strength, size, or durability.

In the primary containment 12, the primary mesh bottom 41(primary mesh level) is a semi-permeable barrier or mesh made of a metal screen or natural fiber screen such as silk, synthetic screen such as polyester, monofilament, or nylon screen, or any other flexible sieve material known in the art. The mesh bottom 41 can be made from a silk screen material that is a loosely woven or knitted fabric that has numerous closely spaced holes to allow fine plant components to pass through. In one embodiment, a silk netting is used for the primary mesh bottom 41 and measured in microns. In another embodiment of the invention, the mesh bottom 41 is made of a woven, knit, welded, etched, or otherwise formed steel or other metal. The preferred mesh range of the primary mesh bottom 41 is determined in microns measured in whole sizes such as a no. 30 to 100 silk netting mesh screen. The primary mesh bottom 41 may be removably or irremovably attached. The removable attachment means may be accomplished through a Velcro attachment of the outer facing border of the mesh bottom 41 to in inner surface of the primary containment 12. Velcro attachment means, or other similar attachment means may be incorporated for easy removal of the mesh, and to further facilitate separate cleaning of the mesh as well as providing replacement or new mesh into the unit.

In another embodiment a level of larger grade mesh 51 which may be removably attached. In a preferred embodiment, the mesh 51 is fixedly attached with nuts 52 and bolts 53, as seen in FIG. 4. This mesh level 51 is attached as an initial grinder level in the primary containment 12, resting a distance above the primary mesh bottom 41 surface of the primary containment 12, as illustrated in FIG. 3B, FIG. 4 and FIG. 5. The plant or herbs to be sifted are initially placed and held in the primary chamber 43.

In the secondary containment 13, the secondary mesh bottom 42 (secondary mesh level) is also made of a silk netting measured in microns, ideally of a smaller or finer grade mesh than the primary containment mesh bottom 41. The preferred range of the secondary mesh bottom 42 is no. 100 to 400 mesh screen so as to sift through the finer particulars of the plant as small as plant pollen, depending on the fineness desired. The secondary mesh bottom 42 may be removably or irremovably attached. The removable attachment means may be accomplished through a Velcro attachment of the outer facing border of the mesh bottom 42 to in inner surface of the secondary containment 13. The plant components sifted from the plant in the primary chamber 43 fall into the secondary chamber 44.

The primary mesh level 41 and secondary mesh level 42 of the primary containment 12 and secondary containment 13 respectively, each correspond to a level of sifting. In an embodiment, at least two levels of sifting, at progressively smaller grades, allows for further refinement of the sifted plant or herb component.

In other embodiments of the current invention, more than two levels of sifting can be used; more specifically, three or more levels with progressively finer or smaller mesh levels can be used for sifting, as in FIG. 3B and FIG. 5. Hence, more than two levels of sifting can further refine of separate out unwanted components, such as leaves, stems, flowers and the like.

The collection base 11 functions to collect the sifted plant components. In an embodiment of the invention, the collection base 11 is a 3.5 gallon cylindrical container or bucket with a sealed bottom and an open top as illustrated in FIGS. 3A and 3B. Other sized gallon containers such as five gallon container may be used depending on the amount of product needed. The collection base 11 is made of a stiff plastic, or any other stiff and durable material as known in the art. The outside cylindrical face of the collection base 11 contains two stacking members 31 that allow the secondary containment unit 13 to stack into the collection base 11, as illustrated in FIGS. 3A and 3B. The stacking members 31 support the weight of the primary and secondary containments 12, 13 over the collection base 11 such that a collection chamber 45 is formed. In an embodiment, the chamber 45 is at least about 11 inches in height.

A removable lid 14 of the containment unit 10 fits snuggly over the primary containment 12 and prevents any plant material from inadvertently being expunged from the primary chamber 43.

In an embodiment of the invention, the containment unit 10 is a portable, separate unit that is removable from the platform unit 20. Additionally, the containment unit 10 can be disassembled, separating the primary containment 12, secondary containment 13 and collection base 11. It is further an embodiment, in which the containment unit is comprised of single chamber with levels of sifting throughout the internal length of the containment unit, without distinguishing between separate containment sections.

As illustrated in FIGS. 1 and 2, the platform unit 20 is comprised of a working table or deck 15 and a base 16. As illustrated in FIGS. 8 and 9, the deck 15 is further comprised of a mount or opening 61, vertical 62 and horizontal 63 support members, a vibrator motor 64 and a strap assembly 65. The deck 15 is further elevated from the base by two extension springs 17 and an arm 18. The springs 17 used may be 1¼ inches diameter and have a high tensile strength. In an embodiment the springs 17 have a tension strength of about three pounds. The springs preferably have enough tension strength to withstand the vibration and agitation motions created by the sifter apparatus. As illustrated in FIGS. 1 and 9, springs 17 with a threaded insert may be used to attach the spring to the deck 15. In an embodiment, the springs are a high strength tensile spring of 1¼ inches diameter by 4¼ inches.

The mount or opening 61 on the upper face of the deck 15 allows the containment unit 10 to fit into the deck 15 at an inset position. The opening 61 is shaped and sized to receive the containment unit 10 such that the containment unit fits snuggly within the opening 61 without extraneous movement. In an embodiment of the current invention, the opening is circular recessed section. In other embodiments, the mount 61 may comprise raised wall segments along a periphery of the position where the containment unit is to be seated, the wall segments extending upward directly from the surface of the deck to secure the containment unit so as not to require a recessed opening in the surface of the deck.

As illustrated in FIG. 8, vertical support members 62 affix and stabilize a horizontal support member 63 at least two inches below the upper surface of the deck 15. The configuration of the retaining mount 61, allows for the effective transfer of vibration to the containment unit 10. The vertical support members 62 are fixedly attached to the deck using bolts or screws. In an embodiment of the present invention, four vertical support members 62 affix the horizontal support member 63 to the deck 15, as illustrated in FIG. 8. The horizontal support member 63 is an annular ring with a width of approximately two inches. In this embodiment, the annular ring supports the containment unit 10, the weight of the containment unit and contents of the containment unit resting on the annular ring.

The containment unit 10 is secured into the opening 61 of the deck 15 and prevented from disassembling during usage by a strap assembly 65 that is affixed to the deck by two anchors 66. In an embodiment of the present invention, the strap assembly 65 is comprised of two anchors 66, two straps 67 and a buckle 68, for example a nylon ratchet strap. As illustrated in FIGS. 1, 8 and 9, the two anchors 66 are affixed to the deck 15 on opposite ends of the opening 61. On a first strap 67, the proximal end of the strap is attached to the anchor 66 and distal end of the strap is attached to a buckle 68. On a second strap, the proximal end of the strap is attached to an anchor 66 and the distal end is free. The two straps are fastened together, using the buckle 68, to secure the containment unit 10 into the opening 61 of the deck 15. In an embodiment as shown in FIG. 1 and FIG. 2, the lid 14 further comprises a strap retainer bracket 69 positioned along and conforming to opposite edges of the lid 14, to guide and provide additional grip to the strap 67 and secure the containment unit 10. Other embodiments may utilize other buckles or fasteners such as cam buckles, over center buckles, and the like.

In another embodiment of the invention, a ratchet buckle 68 is used in the strap assembly 65 to secure the containment unit 10. A ratchet buckle is attached to the distal end of the first strap. The free distal end of the second strap is use to thread into the ratchet buckle. To thread the ratchet buckle, the ratchet buckle is opened to allow access to the take up spool of the ratchet buckle, the second strap is then threaded through the spool and back over the spool. The second strap is then pulled through the spool to tighten and remove excess slack of the strap. Once all the slack is removed, the strap is ratcheted until a tighten tension is achieved. The second strap is then secured into place by putting the ratchet in its closed position. To release the second strap from the ratchet buckle, the ratchet buckle is opened into the open and flattened position. Once the ratchet buckle is in the open position, the second strap can be pulled out and released.

The strap 67 may be made of a webbing material including both natural and synthetic fibers or blends thereof. For example a non-elastic polymer webbing may be used as to secure the containment unit. In other embodiments, a nylon, polypropylene or polyester webbing may be used. Further, any other durable, strong and pliable material with a low stretch rate known in the art. Aside from the strap, the working table 15 and its parts thereof are made of steel or any other strong and durable metal of the like known in the art. The strap material, working table and its parts are preferably capable of supporting a stress load of 400 pounds. Higher stress loads may be obtained depending on the specification of the strap material strength.

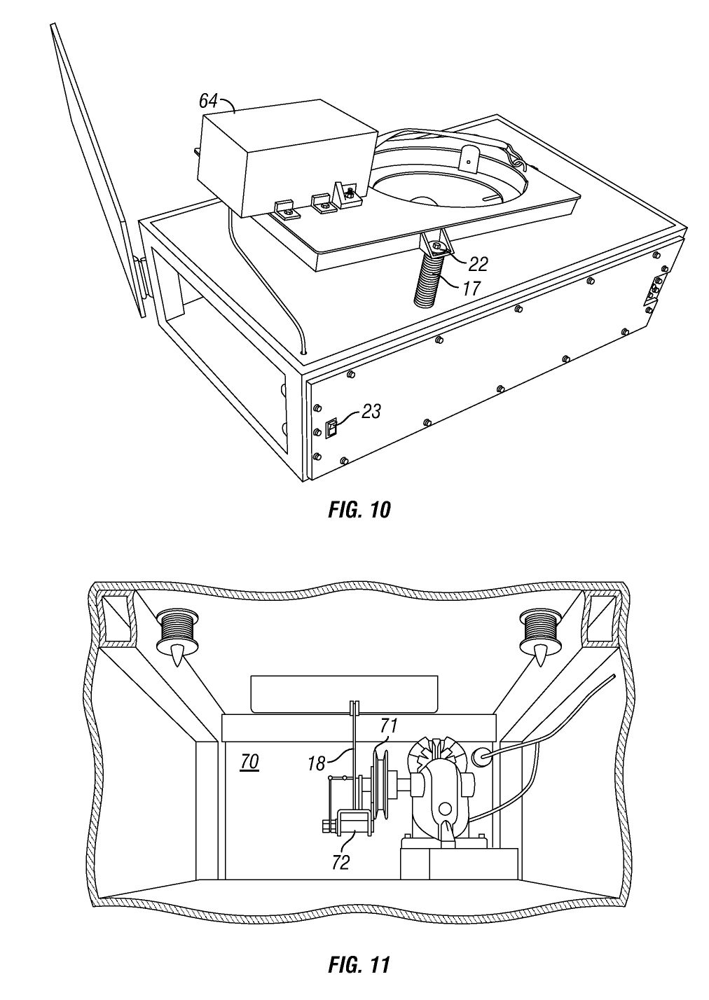

As illustrated in FIGS. 8 and 10, a vibrator motor 64 is fixedly attached to the deck 15 and when operating, vibrates the deck and the secured containment unit. In one embodiment, a 60 pound vibrator motor is encased inside a metal housing and bolted or screwed onto the deck.

The base 16 of the platform unit 20 functions as the foundation for the apparatus, stabilizing and supporting the containment unit 10 and the deck 15 during use. In an embodiment of the invention, the base 16 is comprised of a metal box approximately 29 inches in length, 11 inches in height and 18 inches in width, as illustrated in FIGS. 1 and 2. In an embodiment of the invention, the front face of the base contains a hinged metal door 19 that allows access to the interior of the box, see FIG. 9. In another embodiment of the invention the back face of the base may also contain a hinged door, allowing access to the interior of the base, see FIG. 10.

Inside the base 16 is a gear motor that functions to provide an agitation movement to the working table 15 and containment unit 10, as seen in FIG. 11. In one embodiment, the gear motor, powered by an electrical source, contains a gear. In an embodiment of the invention, a 100 RPM gear motor is used. A rod 72, affixed to the gear 71, is connected to an arm 18 such that the rod 72 rotates within the proximal end of the arm 18. The distal end of the arm is fixedly attached to the front end of the deck 15, through the slot 25 on the top surface of the base 16 as illustrated in FIGS. 1, 2 and 8. When the gear motor is powered on, the gear 71 rotates in a circular motion, and the rod 72 rotates in a similar circular path. The rotation of the rod 72 in turn moves the arm 18 in an up and down and diagonal rocking movement, causing an agitation motion. This agitation motion translates to the deck 15, the containment unit 10 and anything contained inside the containment unit. The agitation motion or agitation provided by the motorized gear and hence the arm may be a cylindrical or a rotating up and down and horizontal, or tossing/rocking motion. In an embodiment of the invention, a 100 RPM gear motor is used.

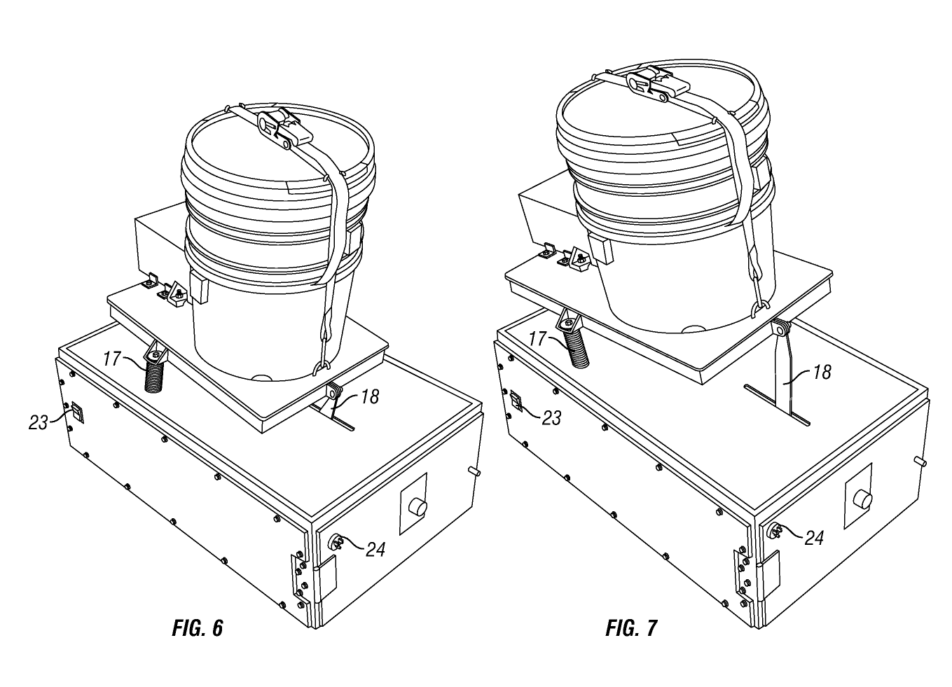

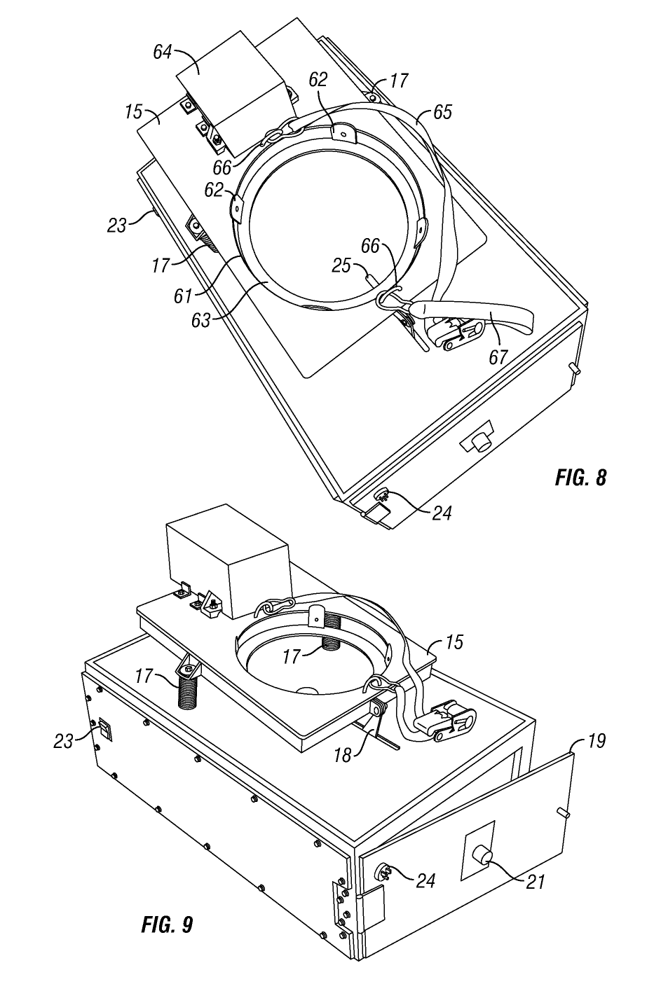

The power of the gear motor along with the length of the arm 18 provide for a highly rapid and intense agitation. As shown in FIG. 6, the agitation of the deck is illustrated where the arm 18 of the gear motor is in lowest, retracted position, thereby causing the deck to rock forward. Similarly, as shown in FIG. 7, the agitation of the deck is illustrated where the arm 18 of the gear motor is in an extended position, thereby causing the deck to rock in the reverse direction. This rocking/agitation action is rapidly repeated as desired at a high speed along with the operation of the vibrator motor 64 applying intense vibration to the deck independently or simultaneously with the agitation. In an embodiment, the length of the drive arm 18 connected to the deck and the motor is about 10¼ inches, and the height of the deck 15 sits at about 4¼ inches above the base. In full extension, the front of the deck is agitated back and upward to a point about 7½ inches above the base. The rocking angle of the working table 15 ranges about 15 degrees to 45 degrees.

The speed of the motorized gear and hence the agitation can be controlled. In an embodiment of the invention, a solid state variable speed motor controller is used to control the speed of the motorized gear. The dial/knob 21 of the motor controller is positioned outside the front face of the base, as illustrated in FIGS. 1, 2 and 9. The control dial 21 controls motor speed from 20% to 100% of rotational power. In addition, a toggle switch 23 is inserted, as shown for example on the base 16, to provide toggling amongst 1) vibration only; 2) vibration with agitation; or 3) agitation only.

The deck 15 of the apparatus is fixedly attached to the base 16 by two steel springs 17, as illustrated in FIGS. 1, 2 and 9. In an embodiment of the invention, 1¼ inches sized high tensile springs are used. For each spring, the proximal end is attached to the top face of the base 16, while the distal end is attached to either the right or the left face of the deck 15. The right and left face of the deck each contain an attachment member 22, enabling the deck to be fixedly attached to the spring and hence the base 16. The spring 17 can be attached to the deck and the base with screw connections, such as ¼ inch bolts, or as is known in the art.

In another embodiment of the present invention, the apparatus is used to separate a plant or herb from smaller components of the plant or herb. The containment unit 10 is assembled with the primary containment 12 fit into the secondary containment 13 and the primary and secondary containment fit into the collection base 11. The plant or herb is first placed into the primary chamber 43 of the containment unit. The containment unit is closed with the removable lid 14 and placed through the opening 61 of the deck 15. The straps of the strap assembly 65 are belted or tied together to secure the containment unit 10 onto the deck 15. The straps 67 secure the unit such that the lid 14 is prevented from opening and the containment unit 10 is tightly bound to the deck 15 during use.

After the containment unit 10 is strapped onto the deck 15, the vibrator motor 64 can be turned on to begin the sifting. Alternatively or in conjunction to the vibrating motion, the gear motor 70 is turned on to apply movement to the containment unit 10, the motion agitates the plant or herb such that their components are sifted and fall into the collection chamber. The vibrator motor 64 may utilize an external or internal power source. In an embodiment of the invention, a 60 lb vibrator motor 64 is used. In an embodiment, as shown in FIG. 1 and FIG. 10, a power cord for the vibrator 64 and the agitator motor 70, runs through the base 16 and the plug 24 protrudes conveniently from the base door 19 to accept a 110V power source. As noted above, a toggle switch 23 provides a desired application of vibration and/or agitation.

In an embodiment of the invention, the containment unit 10 contains two grades of sieving, and both vibration and agitation are used to sift the plant components from the plant. Up to about 1 pound of the initial plant component is placed into the primary chamber 43. The plant is then vibrated and agitated for approximately five minutes. During the vibration and agitation, plant components fall through the primary mesh 41 into the secondary chamber 44; and from the secondary chamber 44, the plant components are further refined and sifted by moving through the secondary mesh 42 and into the collection chamber 45. After the sifting is complete, the vibration and agitation is turned off, the straps are released or loosened, and the containment unit is disassembled to retrieve the sifted plant components from the collection base 11 of the containment unit 10.

In another embodiment, dry ice is placed inside the primary chamber with the plant or herbs to enhance the yield and ease of the sifting. The dry ice facilitates the release of the refined product from the starting plant material and is initially added to the top most sifting layer along with the plant material before the containment unit is sealed. In other embodiments, sealed ice packs or gel packs are incorporated to the sifting levels to facilitate the refinement process.

According to an embodiment, an initial input of unrefined plant component is processed through an operating cycle of the device. The unrefined plant component (raw material) is placed at the top level of the containment unit 10, sealed within and securely mounted to the working table 15. The agitation step is initiated and then the vibration, operating for approximately five minutes for a cycle. The plant component is sifted vigorously through the device. An initial input of about one pound of raw material results in a yield of approximately one ounce of refined plant/herbal extract. The desired plant/herb extract is typically a very fine, crystalline product, resembling fine clay. Based on a typical operational session run constantly for two days, the resulting yield is approximately 10 pounds of refined sifted product, depending on the quality of the initial plant material.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments or alternatives of the foregoing description.

We claim:

1. An apparatus for sifting plant or herb components comprising:
a containment unit comprising
a primary containment having a primary mesh level,
a secondary containment having a secondary mesh level,
a collection base and a removable lid,
wherein the lid covers the primary containment to form a primary chamber, the primary containment stackable into the secondary containment, and the secondary containment stackable into the collection base, the secondary mesh level having a smaller grade than the primary mesh level;
a platform unit comprising a deck connected to a base with at least one resilient member separating the deck from a top surface of the base, the deck having a mount shaped to seat the containment unit above the top surface of the base, the containment unit further secured into the mount by a strap assembly;
a vibrator motor attached to the deck; and
a gear motor housed within the base, the gear motor operatively connected with an arm engaged with the deck, wherein operation of the gear motor provides an agitation motion to the deck.

2. The apparatus of claim 1, wherein the strap assembly further comprising: a first strap and a second strap, each strap having a proximal end and a distal end respectively, the proximal ends of the first strap and the second strap fixedly attached to the deck, and the distal ends of the first strap and the second strap are engaged together around the containment unit with a connector assembly.

3. The apparatus of claim 2, wherein the connector assembly comprises a ratchet buckle.

4. The apparatus of claim 1, wherein the at least one resilient member comprises one or more springs.

5. The apparatus of claim 4, wherein each of the one or more springs has an initial tension of three pounds.

6. The apparatus of claim 1, wherein the mount comprises a recessed opening.

7. The apparatus of claim 6, further comprising at least two vertical support members fixedly attached to edges of the recessed opening extending inside the opening to a horizontal support member.

8. The apparatus of claim 1, wherein the primary containment, the secondary containment and the collection base are stackable cylindrically-shaped plastic containers.

9. The apparatus of claim 1, wherein the primary mesh level has a grade of about 30 to about 100.

10. The apparatus of claim 1, wherein the secondary mesh level has a grade of about 200 to about 400.

11. The apparatus of claim 1, wherein one or more straps of the strap assembly are made of a webbing material.

12. The apparatus of claim 1, further comprising a controller operatively connected to the gear motor, and configured to control power and adjust speed of the gear motor.

13. The apparatus of claim 1, wherein the primary mesh level and the secondary mesh level are removable from the containment unit.

14. The apparatus of claim 1, further comprising an additional removable mesh level positioned a distance above the primary mesh level inside the primary containment.

15. The apparatus of claim 1, wherein the vibrator motor and the gear motor operate independently.

16. An apparatus for sifting plant or herb components comprising:
a containment unit comprising a primary mesh level, a secondary mesh level, a collection base and a removable lid, wherein the lid covers the containment unit to form a chamber, the secondary mesh level having a smaller grade than the primary mesh level;
a platform unit comprising a deck connected to a base with at least one resilient member separating the deck from a top surface of the base, the deck having a mount shaped to seat the containment unit above the top surface of the base, the containment unit further secured into the mount by a strap assembly;
a vibrator motor attached to the deck; and
a gear motor housed within the base, the gear motor operatively connected with an arm engaged with the deck, wherein operation of the gear motor provides an agitation motion to the deck.

17. A method for sifting plant or herb components, utilizing the apparatus of claim 16, the method comprising:
mounting the containment unit into the mount on the deck;
securing the containment unit to the deck with the strap assembly;
vibrating the deck and containment unit with the vibrator motor;
agitating the containment unit by powering the gear motor, wherein the arm rocking the deck at an angle;
sifting a plant component through the primary mesh level and sifting the plant component through the secondary mesh level into the collection base.

18. The method of claim 17, further comprising inserting a plant component within the containment unit and covering the containment unit with the lid, prior to the vibrating step, and the arm rocking the deck at about a 15 degree to about a 45 degree angle.

19. The method of claim 18, wherein the step of inserting the plant component further comprises inserting an amount of dry ice within the containment unit to contact the plant component.

20. The method of claim 17, wherein the vibrating and agitating steps are carried on for about a five minute cycle.
